(19) United States
(12) Patent Application Publication
(10) Pub. No.: US 2017/0293155 A1
(43) Pub. Date: Oct. 12, 2017

(54) Devices and Methods for Speckle Reduction in Scanning Projectors Using Birefringence

(71) Applicant: Microvision, Inc., Redmond, WA (US)

(72) Inventor: Matthieu Saracco, Redmond, WA (US)

(21) Appl. No.: 15/096,638

(22) Filed: Apr. 12, 2016

(51) Int. Cl. G02B 27/48; G02B 5/30; H04N 9/31; G02B 26/10; G03B 21/20; G02B 5/32; G02B 1/11

(52) U.S. Cl. CPC G02B 27/48; G02B 5/32; G02B 5/3083; G02B 1/11; G02B 26/105; G03B 21/2033; H04N 9/3161; H04N 9/3167; H04N 9/3135

(57) ABSTRACT

Devices and methods are described herein that use birefringent elements to reduce speckle. The birefringent elements are angularly separate received laser light into two separated light beams, and then recombine the two angularly separated light beams. At least one scanning mirror is configured to reflect the recombined laser light beam, and a drive circuit is configured to provide an excitation signal to excite motion of the at least one scanning mirror. The angular separation of the light beams generates a relative delay between the two light beams, and this relative delay between light beams generates a temporal incoherence in the recombined light beams. This temporal incoherence can reduce speckle in the projected image.

### FIELD

The present disclosure generally relates to projectors, and more particularly relates to scanning laser projectors.

### BACKGROUND

In scanning laser projectors, pixels are typically generated by modulating light from laser light sources as a scanning mirror scans the modulated light in a raster pattern. One continuing issue in scanning laser projectors is “speckle”. In general, speckle is an image artifact that can reduce the quality of projected images. Speckle occurs when a coherent light source is projected onto a randomly diffusing surface. When highly coherent light reflects off a rough surface, various components of the light combine to form patches of higher intensity light and lower intensity light. To the human eye or other detector with a finite aperture, these patches of variable intensity appear as speckles, as some small portions of the image look brighter than other small portions. Furthermore, these intensity differences can vary depending on observer's position, and thus the speckles can appear to change when the observer moves.

As such, speckle can significantly reduce the quality of image generated by a coherent source, such as laser in a scanning laser projector.

### BRIEF DESCRIPTION OF THE DRAWINGS

FIG. 1 shows a schematic diagram of a scanning laser projector in accordance with various embodiments of the present invention;

FIG. 2. shows a schematic view of a speckle reduction component in accordance with various embodiments of the present invention;

FIG. 3. shows a perspective view of a speckle reduction component in accordance with various embodiments of the present invention;

FIG. 4 shows a schematic view of a scanning laser projector in accordance with various embodiments of the present invention;

FIG. 5 shows a schematic view of a scanning laser projector in accordance with various embodiments of the present invention;

FIG. 6 shows a plan view of a microelectromechanical system (MEMS) device with a scanning mirror in accordance with various embodiments of the present invention;

FIG. 7 shows a block diagram of a mobile device in accordance with various embodiments of the present invention;

FIG. 8 shows a perspective view of a mobile device in accordance with various embodiments of the present invention;

FIG. 9 shows a perspective view of a head-up display system in accordance with various embodiments of the present invention;

FIG. 10 shows a perspective view of eyewear in accordance with various embodiments of the present invention;

FIG. 11 shows a perspective view of a gaming apparatus in accordance with various embodiments of the present invention; and

FIG. 12 shows a perspective view of a gaming apparatus in accordance with various embodiments of the present invention.

### DESCRIPTION OF EMBODIMENTS

In general, the embodiments described herein provide a scanning laser projector that uses birefringent elements to reduce speckle. The birefringent elements are angularly separate received laser light into two separated light beams, and then recombine the two angularly separated light beams. At least one scanning mirror is configured to reflect the recombined laser light beam, and a drive circuit is configured to provide an excitation signal to excite motion of the at least one scanning mirror. Specifically, the motion is excited such that the at least one scanning mirror reflects the recombined laser light beam in a raster pattern of scan lines to form a projected image.

In such embodiments, the angular separation of the light beams generates a relative delay between the two light beams, and this relative delay between light beams generates a temporal incoherence in the recombined light beams. This temporal incoherence reduces speckle in the projected image. Specifically, the temporal incoherence of the two recombined light beams, where the two recombined light beams have an orthogonal polarization orientation, effectively creates two uncorrelated speckle patterns in the projected image. These two uncorrelated speckle patterns partially average out and thus reduce the amount of speckle that is apparent to a viewer of the projected image.

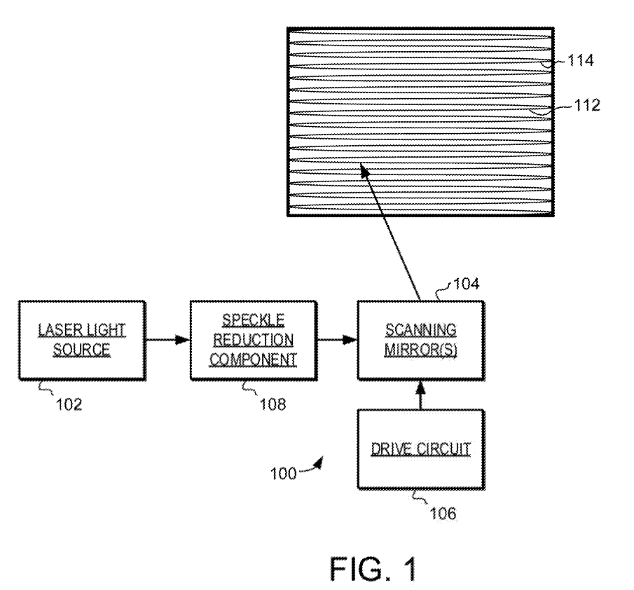

Turning now to FIG. 1, a schematic diagram of a scanning laser projector 100 is illustrated. The scanning laser projector 100 includes a laser 102, scanning mirror(s) 104, a drive circuit 106, and a speckle reduction component 108. During operation, the laser 102 provides a beam of laser light is encoded with pixel data to generate image pixels that are to be projected by the scanning laser projector 100. To facilitate this, the drive circuit 106 controls the movement of the scanning mirror(s) 104. Specifically, the drive circuit 106 provides excitation signal(s) to excite motion of the scanning mirror(s) 104.

The scanning mirror(s) 104 reflect the laser light beam into an image region 112. Specifically, during operation of the scanning light projector 100, the scanning mirror(s) 104 are controlled by the drive circuit 106 to reflect the beams of laser light into a raster pattern 114. This raster pattern 114 of laser light beam generates a projected image. In general, the horizontal motion of the beam of laser light in this raster pattern 114 define rows of pixels in the projected image, while the vertical motion of the beams of laser light in the raster pattern 114 defines a vertical scan rate and thus the number of rows in the projected image.

In accordance with the embodiments described herein, the speckle reduction component 108 is inserted into the optical path of the scanning laser projector 100 to reduce speckle in the projected image. In general, the speckle reduction component 108 uses birefringent elements to reduce speckle in the projected image generated by the scanning laser projector 100. Specifically, the speckle reduction component 108 uses a first birefringent element and a second birefringent element. The first birefringent element is configured to receive laser light from the laser 102 and angularly separate the received laser light into two separated light beams. The second birefringent element is configured to receive the two angularly separated light beams and spatially recombine the two angularly separated light beams. The scanning mirror(s) 104 are configured to reflect the recombined laser light beam, and the drive circuit 106 is configured to provide an excitation signal to excite motion of the scanning mirror(s) 104. Specifically, the motion is excited such that the scanning mirror(s) 104 reflect the recombined laser light beam in the raster pattern 114 of scan lines to form a projected image

In such embodiments, the angular separation of the light beams generates a relative delay between the two light beams. Specifically, the light beam that follows the angled path in the first birefringent element is temporally delayed relative to the light beam that follows the straight path. This relative delay between light beams generates a temporal incoherence when the light beams are recombined. That temporal incoherence continues when the recombined light beams are scanned by scanning mirror(s) 104 into the raster pattern 114 to project an image.

This temporal incoherence in the recombined laser beams that are scanned to project an image results in reduced speckle in the projected image. Specifically, the temporal incoherence of the two recombined light beams, where the two recombined light beams have an orthogonal polarization orientation, effectively creates two uncorrelated speckle patterns in the projected image. These two uncorrelated speckle patterns partially average out and thus reduce the amount of speckle that is apparent to a viewer of the projected image.

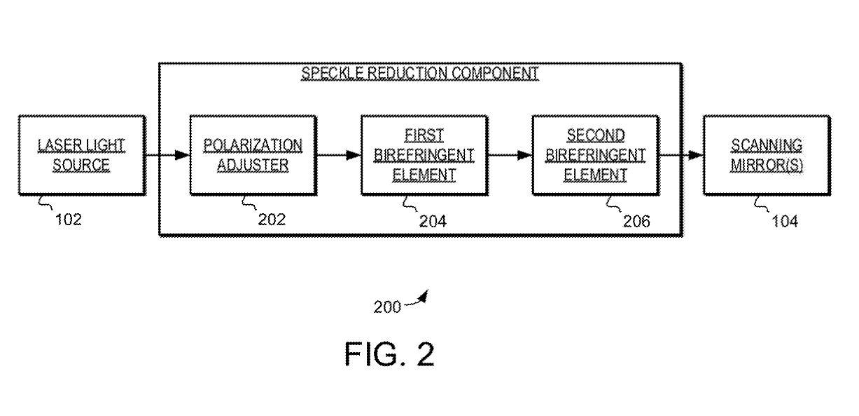

Turning now to FIG. 2, a more detailed embodiment of a speckle reduction component 200 is illustrated. The speckle reduction component 200 includes a polarization adjuster 202, a first birefringent element 204, and a second birefringent element 206. Again, the speckle reduction component 200 is inserted into the optical path of a scanning laser projector to reduce speckle in the projected image. Specifically, the speckle reduction component 200 is configured to receive laser light from a laser light source 102 and output laser light to the scanning mirrors 104. When so configured, the speckle reduction component 200 will reduce speckle in the projected image.

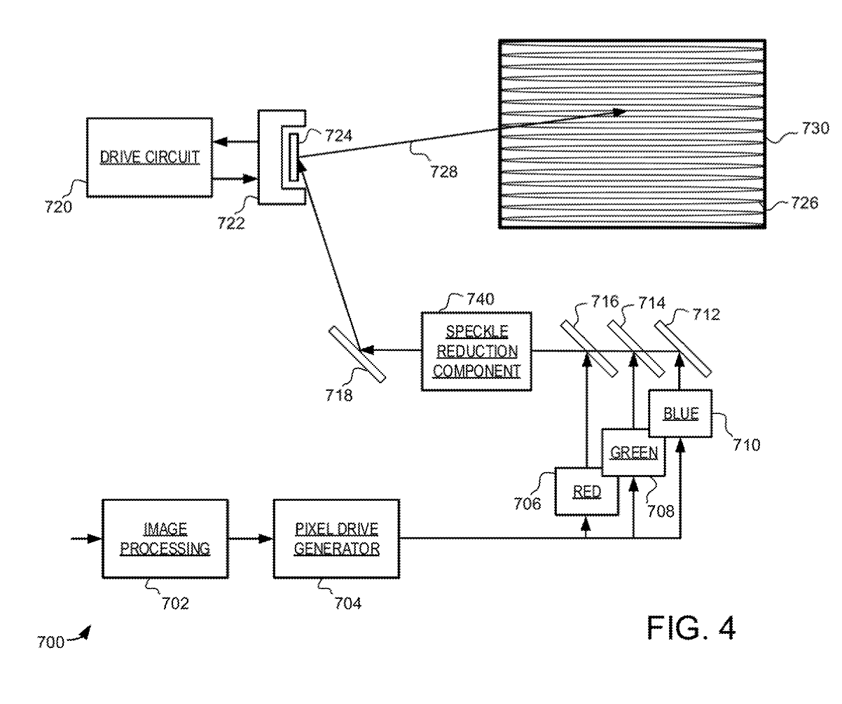

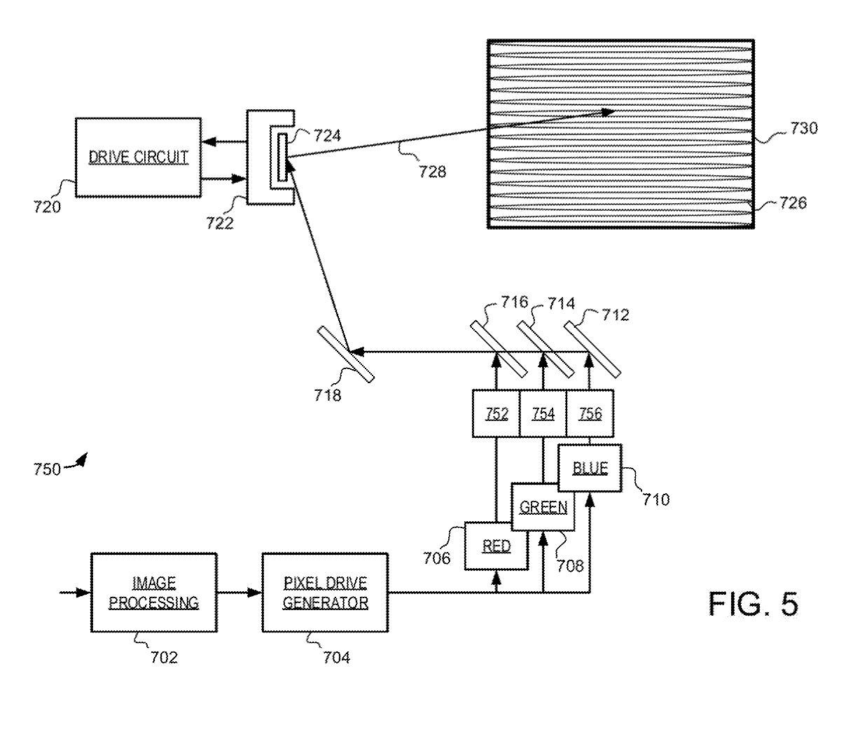

It should be noted that while FIG. 2 shows the speckle reduction component receiving the laser light directly from the laser light source 102, that this is just one example embodiment. In other embodiments there can be additional optical elements inserted between the laser light source 102 and the speckle reduction component 200. Additionally, there can be additional optical elements inserted between the speckle reduction component 200 and the scanning mirrors 104. Specific examples of such other elements will be discussed in greater detail below with reference to the detailed embodiments illustrated in FIGS. 4 and 5.

In general, the speckle reduction component 200 uses the polarization adjuster 202, the first birefringent element 204, and the second birefringent element 206 to introduce a temporal incoherence in the laser light used to project the image, with that temporal incoherence implemented to reduce speckle in the projected image.

Specifically, in this embodiment the laser light source 102 provides a laser light beam, and the polarization adjuster 202 is configured to adjust the polarization of the laser light beam such that it includes power along two orthogonal polarization directions. As such, a variety of different types of devices and components can be used to implement the polarization adjuster 202. For example, both polarization converters and polarization rotators can be used to implement the polarization adjuster 202. Examples of polarization converters that can be used include quarter-wave plates and depolarizers. Examples of polarization rotators that can be used include half-wave plates and configurations that rotate the laser light source 102. In each case, such a polarization adjuster 202 can be implemented to provide the laser light beam with orthogonal polarization components. Furthermore, as will be described in greater detail below, it is generally desirable to implement the polarization adjuster 202 such that the resulting laser light beam has nearly equal optical power in two orthogonal polarization directions. For example, such that the laser light beam has S and P polarization components with half of the overall optical power in each component.

As noted above, in one example a quarter-wave plate can be used to implement the polarization adjuster 202. Specifically, a quarter-wave plate can be implemented to convert linear polarized light from the laser light source 102 to circularly polarized light, where circularly polarized light has orthogonal polarization components with substantially equal optical power. In general, a quarter-wave plate is fabricated to include different indices of refraction for different orientations of light. When linearly polarized light passes through a quarter-wave plate these different indices of refraction cause some polarizations to propagate slower than others. Specifically, to implement a quarter-wave plate, the indices of refraction and dimensions of the quarter-wave plate are selected to introduce a phase shift of 90 degrees (π/2 radians) between orthogonal polarizations. Such a configuration will cause linearly polarized light to be converted to circular polarized light and vice versa, and thus can be used as the polarization adjuster 202.

In another implementation, the polarization adjuster 202 can be implemented with a half-wave plate that is configured to rotate polarization by 45 degrees (π/4 radians) relative to a plane defined by the ordinary ray and extraordinary ray created in the first birefringent element 204. Such an implementation is equivalent to the rotating the laser light source 102 relative the plane defined by the ordinary ray and extraordinary ray created in the first birefringent element 204, and thus can be used to provide for the splitting of the laser light beam into components with nearly equal optical power based on the two orthogonal polarization directions.

In yet another implementation, the polarization adjuster 202 can be implemented with a polarizing element that divides the laser light beam power between two orthogonal polarizations. For example, a depolarizer such as a depolarizing filter or polarization scrambling device can be configured to scramble the polarization such that it includes two orthogonal polarization directions can be implemented as the polarization adjuster 202.

The first birefringent element 204 and the second birefringent element 206 are each implemented with birefringent material, where the birefringent material has a refractive index that depends on the polarization of light propagating through the material. Such birefringent materials are optically anisotropic, and thus the optical effect of the birefringent material is also dependent upon the direction of propagation in the material.

Such birefringent materials can include crystals with asymmetric crystalline structures and plastics under mechanical stress. As one specific example, uniaxial birefringent crystal material can be used for the first birefringent element 204 and the second birefringent element 206. In general, uniaxial birefringent crystal material has a crystalline structure such that there is one direction with optical anisotropy while the perpendicular directions are all optically equivalent. The direction with optical anisotropy is generally known as the optic axis. For any light propagating through the material there will be a polarization direction perpendicular to the optic axis, generally called an ordinary ray. Conversely, rays that are at least partly in the direction of the optic axis are called extraordinary rays. In uniaxial birefringent crystals ordinary rays will experience a constant refractive index, whereas the refractive index experienced by extraordinary rays will depend on the ray direction as described by an index ellipsoid. In the embodiments of the present invention, this variable index of refraction for extraordinary rays will be used to separate the laser light beam into two separated light beams, with the two separated light beams having orthogonal polarizations.

Furthermore, it should be noted that birefringent material can comprise both positive and negative birefringent material in various embodiments. Specifically, positive birefringent material is that material in which the polarization of the faster light beams is perpendicular to the optic axis, while negative birefringent material is that material in which the polarization of the slower light beams is perpendicular to the optic axis. Again, in various embodiments both positive and negative birefringent materials can be used.

As noted above, a variety of materials can be used in the first birefringent element 204 and the second birefringent element 206. In a typical implementation the materials used would be selected to be transparent to the wavelengths provided by the laser light source 102. As some suitable examples for visible wavelengths, calcite (CaCO₃) and Alpha-BBO (α-BBO, α-BaB₂O₄) can be implemented to provide negative birefringence, and crystalline quartz and Yttrium Orthovanadate (YVO₄) can be implemented to provide positive birefringence.

So implemented, the first birefringent element 204 is configured to receive the laser light beam and angularly separate the received laser light into two separated light beams. Specifically, a laser beam of light incident upon the first birefringent element 204 will be split by polarization into two beams taking different paths, with an angular separation between the two paths. Specifically, incoming light of one polarization (e.g., S polarization) sees a different effective index of refraction compared to incoming light of another polarization (e.g., P polarization). This causes the two different polarizations of light to be refracted at different angles inside the first birefringent element 204, thus forming two light beams in the first birefringent element 204, with the first light beam comprising light of one polarization (e.g., S polarization) and the second light beam comprising light of a different polarization (e.g., P polarization). And again, this refraction at different angles causes an angular separation between the two beams in the first birefringent element 204.

It should be noted that in an embodiment with where the light beam entering the first birefringent element 204 includes nearly equal optical power in orthogonal polarizations, that the resulting two separated light beams will have approximately equal optical power. Stated another way, the first birefringent element 204 provides an approximately 50/50 optical power split, with approximately half the optical power traveling down one optical path and the other half of the optical power propagating down the other optical path. This equal power splitting can improve the effectiveness of the speckle reduction by providing that the two generated speckle patterns have approximately equal brightness and thus can more effectively cancel out and reduce the overall speckle of the projected image.

The second birefringent element 206 is configured to receive the two angularly separated light beams and spatially recombine the two angularly separated light beams. Again, the second birefringent element 206 is implemented with a birefringent material, where the birefringent material has a refractive index that depends on the polarization of light propagating through the material. Thus, the two received light beams will again be refracted at different angles. The second birefringent element 206 is configured such that this refraction at different angles causes the two light beams to spatially recombine inside the second birefringent element 206, thus forming a recombined light beam at the output surface of the second birefringent element 206.

It should be noted that in many typical implementations, the first birefringent element 204 and the second birefringent element 206 are configured to optically identical but arranged in mirror image positions. Thus, the first birefringent element 204 and the second birefringent element 206 can have substantially equal dimensions (e.g., a first length equal to a second length.) Additionally, the various surfaces of the first birefringent element 204 can be substantially planar with the corresponding surfaces on the second birefringent element 206. Finally, various antireflective coatings can be applied to the input and output surfaces of the first birefringent element 204 and the second birefringent element 206.

Because of the separation of the two light beams in the first birefringent element 204 and the second birefringent element 206 a relative delay will be introduced between the two light beams. Specifically, the light beam that follows the angled path in the first birefringent element 204 will travel farther and is thus temporally delayed relative to the light beam that follows the straight path. This relative delay between light beams generates a temporal incoherence when the light beams are recombined. That temporal incoherence continues when the recombined light beams are passed to the scanning mirrors 104 for scanning into the raster pattern to project an image.

This temporal incoherence in the recombined laser beams that are scanned to project an image results in reduced speckle in the projected image. Specifically, the temporal incoherence of two recombined light beams, where the light beams have orthogonal polarization components, effectively creates two speckle patterns, one for each of the two separated light beams. Because each of those two speckle patterns is essentially random and uncorrelated, when recombined the two speckle patterns will partially average out, reducing the amount of speckle that is apparent to a viewer of the projected image.

Specifically, in a typical embodiment such an implementation can reduce the apparent speckle by a factor of √2. This level of speckle reduction can be achieved when the first birefringent element 204 provides an approximately 50/50 optical power split and the relative delay between the two beams is at least equal or greater to the coherence length of the laser light. In general, the coherence length is the propagation distance over which a coherent wave maintains coherence. In one embodiment, with a light source having a Lorentz function distribution (as is common with laser diodes), such a coherence length L_{C} is defined as:

$${L}_{c} = \frac{{λ}^{2}}{πΔλ}$$

where λ is the central wavelength of the laser light, and Δλ is the full width half maximum (FWHM) spectral bandwidth of the laser light. Thus, in a typical embodiment, the first birefringent element 204 and the second birefringent element 206 are sized and otherwise configured to provide a relative delay that is at least equal to the coherence length L_{C}. For example, for a visible laser diode light source with a few nanometers of FWHM spectrum bandwidth, the coherence length would typically be on the order of a few 100 μm. Thus, a few millimeters of path difference provided in the birefringent elements should generally be sufficient to break the coherence length of such a light source.

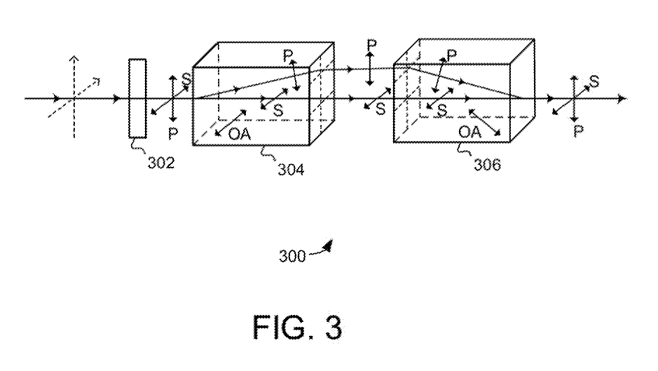

Turning now to FIG. 3, a perspective view of a specific implementation of a speckle reduction component 300 is illustrated. In this illustrated implementation, the speckle reduction component 300 includes a polarization adjuster 302, a first birefringent crystal 304, and a second birefringent crystal 306. The speckle reduction component 300 is an example of the type of device that can be inserted into the optical path of a scanning laser projector to reduce speckle in the projected image. In such an application the speckle reduction component 300 is configured to receive laser light from a laser light source and output laser light to one or more scanning mirrors. When so implemented the speckle reduction component 300 will reduce speckle in the projected image.

In general, the speckle reduction component 300 uses the polarization adjuster 302, the first birefringent crystal 304, and the second birefringent crystal 306 to introduce a temporal incoherence in the laser light used to project the image, with that temporal incoherence implemented to reduce speckle in the projected image.

Specifically, in this illustrated embodiment the polarization adjuster 302 is configured to output orthogonally polarized light having both S and P polarization components. The orthogonally polarized light having both S and P polarization components passes to the first birefringent crystal 304. In this illustrated embodiment the first birefringent crystal 304 and the second birefringent crystal 306 are each implemented with uniaxial birefringent crystal material. In such a material, the crystalline structure has a direction of optical anisotropy called an optical axis. In FIG. 3, the optical axis (OA) is indicated for both the first birefringent crystal 304 and the second birefringent crystal 306. As illustrated, the optical axis (OA) for each of the first birefringent crystal 304 and the second birefringent crystal 306 is tilted relative to the orthogonal axis. In such a configuration implemented with uniaxial birefringent crystal material, ordinary rays will experience a constant refractive index, while extraordinary rays experience variable refractive indices. Furthermore, in this illustrated embodiment the first birefringent crystal 304 and the second birefringent crystal 306 have the same optical properties, are arranged in mirror-image positions, have substantially equal lengths, and the input and output surfaces are parallel. Not shown in FIG. 3 would be antireflective coatings that are applied to input and output surfaces.

When the orthogonally polarized beam of light outputted by the polarization adjuster 302 is incident upon the input surface of the first birefringent crystal 304, the light having S polarization sees a different effective index of refraction compared to the light having P polarization. Specifically, because the orthogonally polarized beam of light is normal to the input surface of the first birefringent crystal 304, the S polarization light comprises an ordinary ray and travels straight through without refraction, while the P polarization light comprises an extraordinary ray and experiences refraction. This causes the two different polarizations of light to travel along different paths inside the first birefringent crystal 304, thus forming two light beams in the first birefringent crystal 304, with the first light beam comprising S polarization light and the second light beam comprising P polarization light. Because this splitting is done by polarization, the two separated light beams will have approximately equal power.

In FIG. 3, the second light beam of P polarization light is illustrated angling away from the light beam of the S polarization light until both beams hit the output surface of the first birefringent crystal. The two light beams then separately continue until both beams impact the input surface of the second birefringent crystal 304. Again, the second birefringent crystal 306 is implemented with a birefringent material, where the birefringent material has a refractive index that depends on the polarization of light propagating through the material. Thus, the S polarization light beam and the P polarization light beam will be refracted at different angles, causing the two light beams to angle together and spatially recombine at the output surface of the second birefringent crystal 304.

As can be seen in FIG. 3, the P polarization light has a longer optical path compared to the S polarization light. Because of this longer path, the P polarization light beam will be delayed in time relative to the S polarization light beam when recombined at the output surface. This generates a temporal incoherence in the recombined light beam, and that temporal incoherence continues when the recombined light beam is scanned to project an image. Furthermore, because the P polarization light beam and the S polarization light beam have orthogonal polarization orientation, that temporal incoherence in the recombined light beam will result in two uncorrelated speckle patterns in the projected image. These two uncorrelated speckle patterns will partially average out and thus reduce the amount of speckle that is apparent to a viewer of the projected image.

Turning now to FIG. 4, a schematic view of a scanning laser projector 700 is illustrated. The scanning laser projector 700 is a more detailed example of the type of system that can be used in accordance with various embodiments of the present invention. Scanning laser projector 700 includes an image processing component 702, a pixel drive generator 704, a red laser module 706, a green laser module 708, and a blue laser module 710. Light from the three laser modules is combined with dichroics 712, 714, and 716. Scanning laser projector 700 also includes fold mirror 718, drive circuit 720, and MEMS device 722 with scanning mirror 724.

In operation, image processing component 702 processes video content at using two dimensional interpolation algorithms to determine the appropriate spatial image content for each scan position at which an output pixel is to be displayed by the pixel drive generator. For example, the video content may represent a grid of pixels at any resolution (e.g., 640×480, 848×480, 1280×720, 1920×1080). The input light intensity encoding typically represents the light intensity in 8, 10, 12 bit or higher resolutions.

This content is then mapped to a commanded current for each of the red, green, and blue laser sources such that the output intensity from the lasers is consistent with the input image content. In some embodiments, this process occurs at output pixel rates in excess of 150 MHz. The laser beams are then directed onto an ultra-high speed gimbal mounted 2-dimensional bi-axial laser scanning mirror 724. In some embodiments, this bi-axial scanning mirror is fabricated from silicon using MEMS processes. The vertical axis of rotation is operated quasi-statically and creates a vertical sawtooth raster trajectory. The vertical axis is also referred to as the slow-scan axis. The horizontal axis is operated on a resonant vibrational mode of the scanning mirror. In some embodiments, the MEMS device uses electromagnetic actuation, achieved using a miniature assembly containing the MEMS die and small subassemblies of permanent magnets and an electrical interface, although the various embodiments are not limited in this respect. For example, some embodiments employ electrostatic or piezoelectric actuation. Any type of mirror actuation may be employed without departing from the scope of the present invention.

The horizontal resonant axis is also referred to as the fast-scan axis. In some embodiments, raster pattern 726 is formed by combining a sinusoidal component on the horizontal axis and a sawtooth component on the vertical axis. In these embodiments, output beam 728 sweeps back and forth left-to-right in a sinusoidal pattern, and sweeps vertically (top-to-bottom) in a sawtooth pattern with the display blanked during flyback (bottom-to-top).

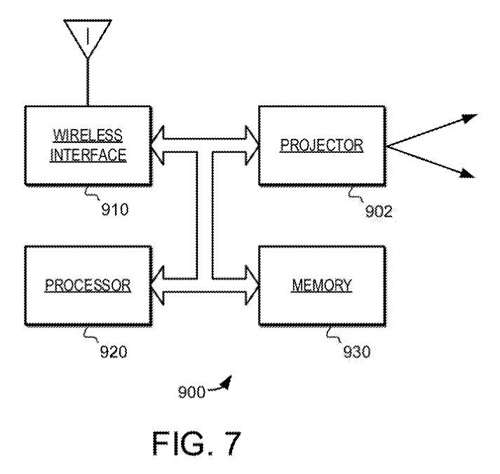

It should be noted that FIG. 7 illustrates the sinusoidal pattern as the beam sweeps vertically top-to-bottom, but does not show the flyback from bottom-to-top. In other embodiments, the vertical sweep is controlled with a triangular wave such that there is no flyback. In still further embodiments, the vertical sweep is sinusoidal. The various embodiments of the invention are not limited by the waveforms used to control the vertical and horizontal sweep or the resulting raster pattern 726.

The drive circuit 720 provides a drive signal to MEMS device 722. The drive signal includes an excitation signal to control the resonant angular motion of scanning mirror 724 on the fast-scan axis, and also includes slow scan drive signal to cause deflection on the slow-scan axis. The resulting mirror deflection on both the fast and slow-scan axes causes output beam 728 to generate a raster scan 726 in an image region 730. In operation, the laser light sources produce light pulses for each output pixel and scanning mirror 724 reflects the light pulses as beam 728 traverses the raster pattern 726. Drive circuit 720 also receives a feedback signal from MEMS device 722. The feedback signal from the MEMS device 722 can describe the maximum deflection angle of the mirror, also referred to herein as the amplitude of the feedback signal. This feedback signal is provided to the drive circuit 720, and is used by the drive circuit 720 to accurately control the motion of the scanning mirror 724.

In operation, drive circuit 720 excites resonant motion of scanning mirror 724 such that the amplitude of the feedback signal is constant. This provides for a constant maximum angular deflection on the fast-scan axis as shown in raster pattern 726. The excitation signal used to excite resonant motion of scanning mirror 724 can include both amplitude and a phase. Drive circuit 720 includes feedback circuit(s) that modifies the excitation signal amplitude to keep the feedback signal amplitude substantially constant. Additionally, the drive circuit 720 can modify the excitation signal to control the horizontal phase alignment and vertical position of the raster pattern 726.

To facilitate this, drive circuit 720 may be implemented in hardware, a programmable processor, or in any combination. For example, in some embodiments, drive circuit 720 is implemented in an application specific integrated circuit (ASIC). Further, in some embodiments, some of the faster data path control is performed in an ASIC and overall control is provided by a software programmable microprocessor.

It should be noted that while FIG. 4 illustrates an embodiment with a single MEMS device 722 and a single scanning mirror 724, that this is just one example implementation. As another example, a scanning laser projector could instead be implemented with scanning mirror assembly that includes two scanning mirrors, with one mirror configured to deflect along one axis and another mirror configured to deflect along a second axis that is largely perpendicular to the first axis.

Such an embodiment could include a second MEMS device, a second scanning mirror, and a second drive circuit. The first scanning mirror could be configured to generate horizontal scanning motion, and the second scanning mirror configured to generate vertical motion. Thus, the motion of one scanning mirror determines the horizontal scan amplitude and the motion of the other scanning mirror determines the vertical scan amplitude.

Finally, although red, green, and blue laser light sources are shown in FIG. 7A, the various embodiments are not limited by the wavelength of light emitted by the laser light sources. For example, in some embodiments, non-visible light (e.g., infrared light) is emitted instead of, or in addition to, visible light.

In accordance with the embodiments described herein, a speckle reduction component 740 is inserted into the optical path. The speckle reduction component can be implemented with any of the various embodiments described above. As such, the speckle reduction component 740 uses birefringent elements to reduce speckle in the projected image generated by the scanning laser projector 700. Specifically, the speckle reduction component 740 uses a first birefringent element and a second birefringent element. The first birefringent element is configured to receive laser light from the laser modules 706, 708, and 710, and angularly separate the received laser light into two separated light beams. The second birefringent element is configured to receive the two angularly separated light beams and spatially recombine the two angularly separated light beams. As described above, this introduces a temporal incoherence in the recombined light beams, and that temporal incoherence results in reduced speckle in the projected image.

It should be noted that in this embodiment the speckle reduction component 740 operates on the laser light after the laser light of different colors (from red laser module 706, a green laser module 708, and a blue laser module 710) have been combined with the dichroics 712, 714, and 716. However, this is just one example, and other embodiments are possible.

For example, turning now to FIG. 5, a second schematic view of a scanning laser projector 700 is illustrated. The scanning laser projector 750 is another example of the type of system that can be used in accordance with various embodiments of the present invention. Scanning laser projector 750 is similar to that of projector 700 illustrated in FIG. 4, but instead uses three separate speckle reduction components 752, 754 and 756. Specifically, the scanning laser projector 750 uses separate speckle reduction components 752, 754 and 756, with one for each color laser outputted by the red laser module 706, a green laser module 708, and a blue laser module 710. Again, this is just one example of how such speckle reduction components can be implemented into a scanning laser projector.

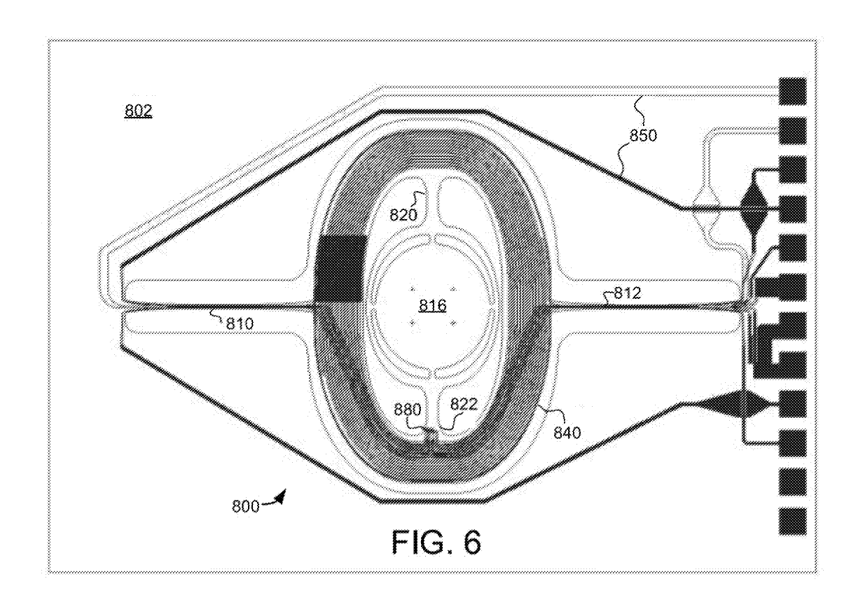

Turning now to FIG. 6, a plan view of a microelectromechanical system (MEMS) device with a scanning mirror is illustrated. MEMS device 800 includes fixed platform 802, scanning platform 840, and scanning mirror 816. Scanning platform 840 is coupled to fixed platform 802 by flexures 810 and 812, and scanning mirror 16 is coupled to scanning platform 840 by flexures 820 and 822. Scanning platform 840 has a drive coil connected to drive lines 850, which are driven by a drive signal provided from a drive circuit (e.g., drive circuit 720). The drive signal includes an excitation signal to excite resonant motion of scanning mirror 816 on the fast-scan axis, and also includes a slow-scan drive signal to cause non-resonant motion of scanning platform 840 on the slow-scan axis. Current drive into drive lines 850 produces a current in the drive coil. In operation, an external magnetic field source (not shown) imposes a magnetic field on the drive coil. The magnetic field imposed on the drive coil by the external magnetic field source has a component in the plane of the coil, and is oriented non-orthogonally with respect to the two drive axes. The in-plane current in the coil windings interacts with the in-plane magnetic field to produce out-of-plane Lorentz forces on the conductors. Since the drive current forms a loop on scanning platform 840, the current reverses sign across the scan axes. This means the Lorentz forces also reverse sign across the scan axes, resulting in a torque in the plane of and normal to the magnetic field. This combined torque produces responses in the two scan directions depending on the frequency content of the torque.

The long axis of flexures 810 and 812 form a pivot axis. Flexures 810 and 812 are flexible members that undergo a torsional flexure, thereby allowing scanning platform 840 to rotate on the pivot axis and have an angular displacement relative to fixed platform 802. Flexures 810 and 812 are not limited to torsional embodiments as shown in FIG. 6. For example, in some embodiments, flexures 810 and 812 take on other shapes such as arcs, “S” shapes, or other serpentine shapes. The term “flexure” as used herein refers to any flexible member coupling a scanning platform to another platform (scanning or fixed), and capable of movement that allows the scanning platform to have an angular displacement with respect to the other platform.

Scanning mirror 816 pivots on a first axis formed by flexures 820 and 822, and pivots on a second axis formed by flexures 810 and 812. The first axis is referred to herein as the horizontal axis or fast-scan axis, and the second axis is referred to herein as the vertical axis or slow-scan axis. In some embodiments, scanning mirror 816 scans at a mechanically resonant frequency on the horizontal axis resulting in a sinusoidal horizontal sweep. Further, in some embodiments, scanning mirror 816 scans vertically at a nonresonant frequency, so the vertical scan frequency can be controlled independently.

In a typical embodiment the MEMS device 800 will also incorporates one or more integrated piezoresistive position sensors. For example, piezoresistive sensor 880 can be configured to produces a voltage that represents the displacement of mirror 816 with respect to scanning platform 840, and this voltage can be provided back to the drive circuit. Furthermore, in some embodiments, positions sensors are provided on one scan axis while in other embodiments position sensors are provided for both axes.

It should be noted that the MEMS device 800 is provided as an example, and the various embodiments of the invention are not limited to this specific implementation. For example, any scanning mirror capable of sweeping in two dimensions to reflect a light beam in a raster pattern may be incorporated without departing from the scope of the present invention. Also for example, any combination of scanning mirrors (e.g., two mirrors: one for each axis) may be utilized to reflect a light beam in a raster pattern. Further, any type of mirror drive mechanism may be utilized without departing from the scope of the present invention. For example, although MEMS device 800 uses a drive coil on a moving platform with a static magnetic field, other embodiments may include a magnet on a moving platform with drive coil on a fixed platform. Further, the mirror drive mechanism may include an electrostatic drive mechanism.

The scanning laser projectors described above (e.g., scanning laser projector 100 of FIG. 1) can be implemented in a wide variety of devices and for a wide variety of applications. Several specific examples of these types of devices will not be discussed with reference to FIGS. 7-12. In each case, the various embodiments described above can be implemented with or as part of such a device.

Turning to FIG. 7, a block diagram of a mobile device 900 in accordance with various embodiments is illustrated. Specifically, mobile device 900 is an example of the type of device in which a scanning laser projector as described above can be implemented (e.g., scanning laser projector 100, scanning laser projector 700). As shown in FIG. 7, mobile device 900 includes wireless interface 910, processor 920, memory 930, and scanning laser projector 902. Scanning laser projector 902 includes photodetector(s) configured in an over scanned region signal to provide feedback signal(s) as described above. Scanning laser projector 902 may receive image data from any image source.

For example, in some embodiments, scanning laser projector 902 includes memory that holds still images. In other embodiments, scanning laser projector 902 includes memory that includes video images. In still further embodiments, scanning laser projector 902 displays imagery received from external sources such as connectors, wireless interface 910, a wired interface, or the like.

Wireless interface 910 may include any wireless transmission and/or reception capabilities. For example, in some embodiments, wireless interface 910 includes a network interface card (NIC) capable of communicating over a wireless network. Also for example, in some embodiments, wireless interface 910 may include cellular telephone capabilities. In still further embodiments, wireless interface 910 may include a global positioning system (GPS) receiver. One skilled in the art will understand that wireless interface 910 may include any type of wireless communications capability without departing from the scope of the present invention.

Processor 920 may be any type of processor capable of communicating with the various components in mobile device 900. For example, processor 920 may be an embedded processor available from application specific integrated circuit (ASIC) vendors, or may be a commercially available microprocessor. In some embodiments, processor 920 provides image or video data to scanning laser projector 100. The image or video data may be retrieved from wireless interface 910 or may be derived from data retrieved from wireless interface 910. For example, through processor 920, scanning laser projector 902 may display images or video received directly from wireless interface 910. Also for example, processor 920 may provide overlays to add to images and/or video received from wireless interface 910, or may alter stored imagery based on data received from wireless interface 910 (e.g., modifying a map display in GPS embodiments in which wireless interface 910 provides location coordinates).

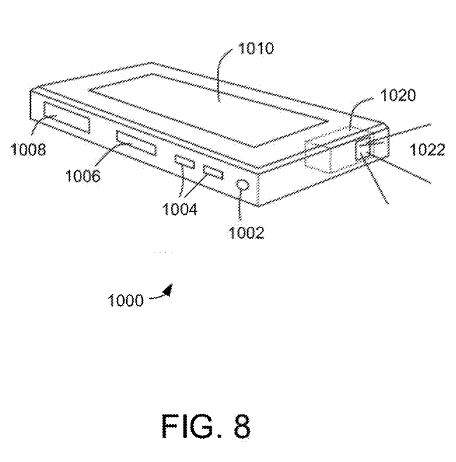

Turning to FIG. 8, a perspective view of a mobile device 1000 in accordance with various embodiments is illustrated. Specifically, mobile device 1000 is an example of the type of device in which a scanning laser projector as described above can be implemented (e.g., scanning laser projector 100, scanning laser projector 700). Mobile device 1000 may be a hand held scanning laser projector with or without communications ability. For example, in some embodiments, mobile device 1000 may be a scanning laser projector with little or no other capabilities. Also for example, in some embodiments, mobile device 1000 may be a device usable for communications, including for example, a cellular phone, a smart phone, a tablet computing device, a global positioning system (GPS) receiver, or the like. Further, mobile device 1000 may be connected to a larger network via a wireless (e.g., cellular), or this device can accept and/or transmit data messages or video content via an unregulated spectrum (e.g., WiFi) connection.

Mobile device 1000 includes scanning laser projector 1020, touch sensitive display 1010, audio port 1002, control buttons 1004, card slot 1006, and audio/video (A/V) port 1008. None of these elements are essential. For example, mobile device may only include scanning laser projector 1020 without any of touch sensitive display 1010, audio port 1002, control buttons 1004, card slot 1006, or A/V port 1008. Some embodiments include a subset of these elements. For example, an accessory projector may include scanning laser projector 1020, control buttons 1004 and A/V port 1008. A smartphone embodiment may combine touch sensitive display device 1010 and projector 1020.

Touch sensitive display 1010 may be any type of display. For example, in some embodiments, touch sensitive display 1010 includes a liquid crystal display (LCD) screen. In some embodiments, display 1010 is not touch sensitive. Display 1010 may or may not always display the image projected by scanning laser projector 1020. For example, an accessory product may always display the projected image on display 1010, whereas a mobile phone embodiment may project a video while displaying different content on display 1010. Some embodiments may include a keypad in addition to touch sensitive display 1010. A/V port 1008 accepts and/or transmits video and/or audio signals. For example, A/V port 1008 may be a digital port, such as a high definition multimedia interface (HDMI) interface that accepts a cable suitable to carry digital audio and video data. Further, A/V port 1008 may include RCA jacks to accept or transmit composite inputs. Still further, A/V port 1008 may include a VGA connector to accept or transmit analog video signals.

In some embodiments, mobile device 1000 may be tethered to an external signal source through A/V port 1008, and mobile device 1000 may project content accepted through A/V port 1008. In other embodiments, mobile device 1000 may be an originator of content, and A/V port 1008 is used to transmit content to a different device.

Audio port 1002 provides audio signals. For example, in some embodiments, mobile device 1000 is a media recorder that can record and play audio and video. In these embodiments, the video may be projected by scanning laser projector 1020 and the audio may be output at audio port 1002.

Mobile device 1000 also includes card slot 1006. In some embodiments, a memory card inserted in card slot 1006 may provide a source for audio to be output at audio port 1002 and/or video data to be projected by scanning laser projector 1020. Card slot 1006 may receive any type of solid state memory device, including for example secure digital (SD) memory cards.

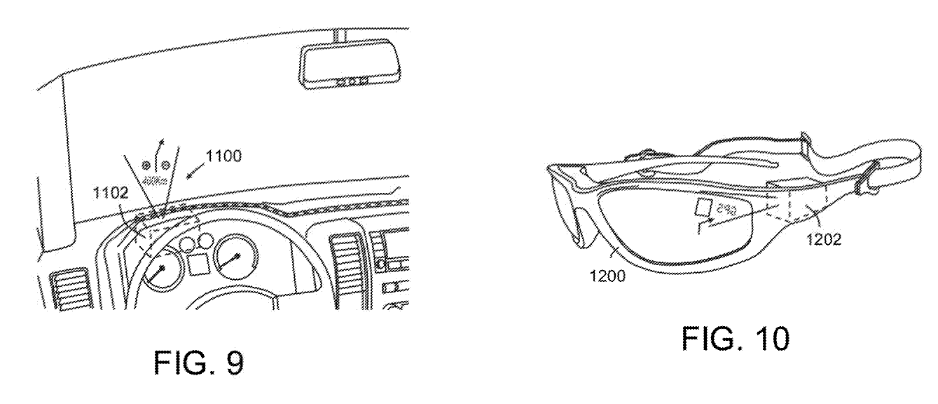

Turning to FIG. 9, a perspective view of a head-up display system 1100 in accordance with various embodiments is illustrated. Specifically, head-up display system 1100 is an example of the type of device in which a scanning laser projector as described above can be implemented (e.g., scanning laser projector 100, scanning laser projector 700). The head-up display system 1100 includes a scanning laser projector 1102. Specifically, the scanning laser projector 1102 is shown mounted in a vehicle dash to project the head-up display. Although an automotive head-up display is shown in FIG. 9, this is not a limitation and other applications are possible. For example, various embodiments include head-up displays in avionics application, air traffic control applications, and other applications.

Turning to FIG. 10, a perspective view of eyewear 1200 in accordance with various embodiments is illustrated. Specifically, eyewear 1200 is an example of the type of device in which a scanning laser projector as described above can be implemented (e.g., scanning laser projector 100, scanning laser projector 700). Eyewear 1200 includes scanning laser projector 1202 to project a display in the eyewear's field of view. In some embodiments, eyewear 1200 is see-through and in other embodiments, eyewear 1200 is opaque. For example, eyewear 1200 may be used in an augmented reality application in which a wearer can see the display from projector 1202 overlaid on the physical world. Also for example, eyewear 1200 may be used in a virtual reality application, in which a wearer's entire view is generated by projector 1202.

Although only one projector 1202 is shown in FIG. 10, this is not a limitation and other implementations are possible. For example, in some embodiments, eyewear 1200 includes two projectors 1202, with one for each eye

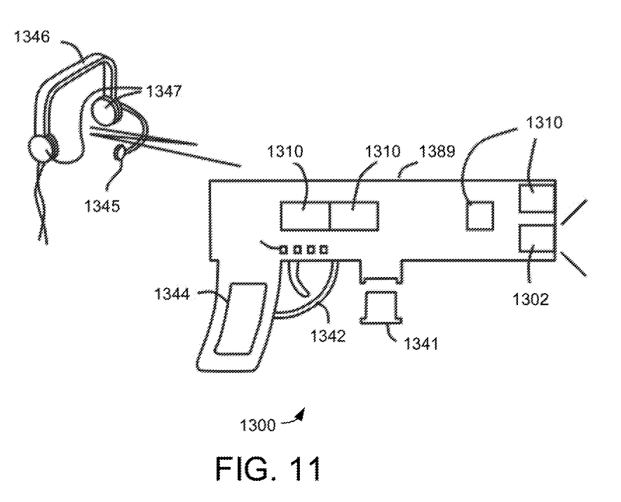

Turning to FIG. 11, a perspective view of a gaming apparatus 1300 in accordance with various embodiments is illustrated. Gaming apparatus 1300 allows a user or users to observe and interact with a gaming environment. In some embodiments, the game is navigated based on the motion, position, or orientation of gaming apparatus 1300, an apparatus that includes scanning laser projector 1302. Other control interfaces, such as manually-operated buttons, foot pedals, or verbal commands, may also contribute to navigation around, or interaction with the gaming environment. For example, in some embodiments, trigger 1342 contributes to the illusion that the user or users are in a first person perspective video game environment, commonly known as a “first person shooter game.” Because the size and brightness of the projected display can be controlled by the gaming application in combination with the user's movement, gaming apparatus 1300 creates a highly believable or “immersive” environment for these users.

Many other first person perspective simulations can also be created by gaming apparatus 1300, for such activities as 3D seismic geo-prospecting, spacewalk planning, jungle canopy exploration, automobile safety instruction, medical education, etc. Tactile interface 1344 may provide a variety of output signals, such as recoil, vibration, shake, rumble, etc. Tactile interface 1344 may also include a touch-sensitive input feature, such as a touch sensitive display screen or a display screen that requires a stylus. Additional tactile interfaces, for example, input and/or output features for a motion sensitive probe are also included in various embodiments of the present invention.

Gaming apparatus 1300 may also include audio output devices, such as integrated audio speakers, remote speakers, or headphones. These sorts of audio output devices may be connected to gaming apparatus 1300 with wires or through a wireless technology. For example, wireless headphones 1346 provide the user with sound effects via a BLUETOOTH™ connection, although any sort of similar wireless technology could be substituted freely. In some embodiments, wireless headphones 1346 may include microphone 1345 or binaural microphone 1347, to allow multiple users, instructors, or observers to communicate. Binaural microphone 1347 typically includes microphones on each ear piece, to capture sounds modified by the user's head shadow. This feature may be used for binaural hearing and sound localization by other simulation participants.

Gaming apparatus 1300 may include any number of sensors 1310 that measure ambient brightness, motion, position, orientation, and the like. For example, gaming apparatus 1300 may detect absolute heading with a digital compass, and detect relative motion with an x-y-z gyroscope or accelerometer. In some embodiments, gaming apparatus 1300 also includes a second accelerometer or gyroscope to detect the relative orientation of the device, or its rapid acceleration or deceleration. In other embodiments, gaming apparatus 1300 may include a Global Positioning Satellite (GPS) sensor, to detect absolute position as the user travels in terrestrial space.

Gaming apparatus 1300 may include battery 1341 and/or diagnostic lights 1343. For example, battery 1341 may be a rechargeable battery, and diagnostic lights 1343 could indicate the current charge of the battery. In another example, battery 1341 may be a removable battery clip, and gaming apparatus 1300 may have an additional battery, electrical capacitor or super-capacitor to allow for continued operation of the apparatus while the discharged battery is replaced with a charged battery. In other embodiments, diagnostic lights 1343 can inform the user or a service technician about the status of the electronic components included within or connected to this device. For example, diagnostic lights 1343 may indicate the strength of a received wireless signal, or the presence or absence of a memory card.

Diagnostic lights 1343 could also be replaced by any small screen, such as an organic light emitting diode or liquid crystal display screen. Such lights or screens could be on the exterior surface of gaming apparatus 1300, or below the surface, if the shell for this apparatus is translucent or transparent. Other components of gaming apparatus 1300 may be removable, detachable or separable from this device. For example, scanning laser projector 1302 may be detachable or separable from gaming housing 1389. In some embodiments, the subcomponents of scanning laser projector 100 may be detachable or separable from gaming housing 1389, and still function.

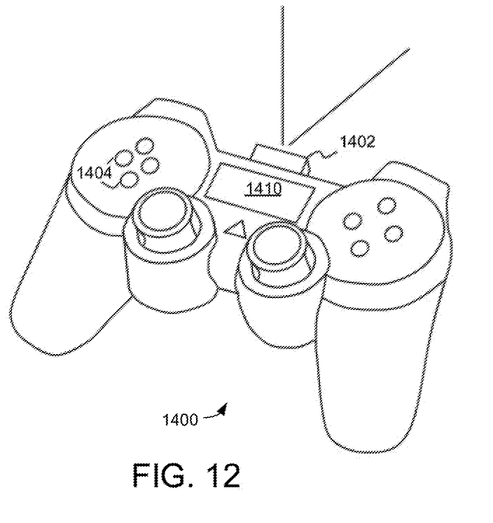

Turning to FIG. 12, a perspective view of a gaming apparatus 1400 in accordance with various embodiments is illustrated. Gaming apparatus 1400 includes buttons 1404, display 1410, and projector 1402. In some embodiments, gaming apparatus 1400 is a standalone apparatus that does not need a larger console for a user to play a game. For example, a user may play a game while watching display 1410 and/or the projected content. In other embodiments, gaming apparatus 1400 operates as a controller for a larger gaming console. In these embodiments, a user may watch a larger screen tethered to the console in combination with watching display 1410 and/or projected content.

In one embodiment, a scanning laser projector is provided. The scanning laser projector comprises: at least one source of laser light; a first birefringent element configured to receive the laser light and angularly separate the laser light into two angularly separated light beams; a second birefringent element configured to receive the two angularly separated light beams and spatially recombine the two angularly separated light beams into a recombined laser light beam; at least one scanning mirror configured to reflect the recombined laser light beam; and a drive circuit configured to provide an excitation signal to excite motion of the scanning mirror to reflect the recombined laser light beam in a raster pattern of scan lines.

In another embodiment, a scanning laser projector is provided, where the scanning laser projector comprises: at least one source of laser light, the laser light having substantially linear polarization; a speckle reduction component, the speckle reduction component configured to receive the laser light, the speckle reduction component including: a polarization adjuster, the polarization adjuster configured to receive the laser light and convert the laser light to orthogonally polarized laser light having orthogonal polarization components with equal optical power; a first birefringent crystal configured to receive the orthogonally polarized laser light and angularly separate the orthogonally polarized laser light into a first light beam having an S polarization and a second light beam having a P polarization, the first birefringent crystal further configured introduce a delay in the second light beam relative to the first light beam and output the first light beam and the delayed second light beam; and a second birefringent crystal positioned proximate to the first birefringent crystal and to configured to receive the first light beam and the delayed second light beam, the second birefringent crystal configured to further delay the delayed second light beam and spatially recombine the delayed second light beam and the first light beam into a recombined laser light beam and output the recombined laser light beam; at least one scanning mirror configured to reflect the recombined laser light beam; and a drive circuit configured to provide an excitation signal to excite motion of the scanning mirror to reflect the recombined laser light beam in a raster pattern of scan lines.

In another embodiment, a method of projecting an image is provided. The method comprises: generating a laser light beam; splitting the laser light beam into a first light beam and a second light beam with a first birefringent element; spatially combining the first light beam and the second light beam with a second birefringent element to generate a recombined laser beam; and exciting motion of a scanning mirror to reflect the recombined laser beam in a raster pattern of scan lines.

In the preceding detailed description, reference was made to the accompanying drawings that show, by way of illustration, specific embodiments in which the invention may be practiced. These embodiments were described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The preceding detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A scanning laser projector, comprising:
at least one source of laser light;
a first birefringent element configured to receive the laser light and angularly separate the laser light into two angularly separated light beams;
a second birefringent element configured to receive the two angularly separated light beams and spatially recombine the two angularly separated light beams into a recombined laser light beam;
at least one scanning mirror configured to reflect the recombined laser light beam; and
a drive circuit configured to provide an excitation signal to excite motion of the scanning mirror to reflect the recombined laser light beam in a raster pattern of scan lines.

2. The scanning laser projector of claim 1, further comprising a polarization adjuster configured to receive the laser light and adjust the laser light to have optical power along two orthogonal polarizations.

3. The scanning laser projector of claim 2, wherein the polarization adjuster comprises a quarter-wave plate configured to receive the laser light and output the laser light to the first birefringent element.

4. The scanning laser projector of claim 1, wherein the two angularly separated light beams comprises a first beam having an S polarization and a second beam having a P polarization.

5. The scanning laser projector of claim 1, wherein first birefringent element and the second birefringent element are together configured to introduce a relative delay between the separated light beams, where the relative delay is greater than a coherence length of the laser light.

6. The scanning laser projector of claim 5, wherein the coherence length is defined as
$${L}_{c} = \frac{{λ}^{2}}{Δλ}$$
where λ is the central wavelength of the laser light, and Δλ is a full width half maximum (FWHM) spectral bandwidth of the laser light.

7. The scanning laser projector of claim 1, wherein the first birefringent element and the second birefringent element each comprise a uniaxial birefringent crystal.

8. The scanning laser projector of claim 1, wherein the first birefringent element has a first input surface and a first output surface, and wherein the second birefringent element has a second input surface and a second output surface, and wherein the first input surface, the first output surface, the second input surface, and the second output surface are all parallel.

9. The scanning laser projector of claim 8, further comprising anti-reflective coatings applied to the first input surface, the first output surface, the second input surface, and the second output surface.

10. The scanning laser projector of claim 1, wherein the first birefringent element has a first length, the second birefringent element has a second length, and wherein the first length is substantially equal to the second length.

11. The scanning laser projector of claim 1, wherein the first birefringent element and the second birefringent element are substantially optically identical and arranged in mirror image positions.

12. A scanning laser projector, comprising:
at least one source of laser light, the laser light having substantially linear polarization;
a speckle reduction component, the speckle reduction component configured to receive the laser light, the speckle reduction component including:
a polarization adjuster, the polarization adjuster configured to receive the laser light and convert the laser light to orthogonally polarized laser light having orthogonal polarization components with equal optical power;
a first birefringent crystal configured to receive the orthogonally polarized laser light and angularly separate the orthogonally polarized laser light into a first light beam having an S polarization and a second light beam having a P polarization, the first birefringent crystal further configured introduce a delay in the second light beam relative to the first light beam and output the first light beam and the delayed second light beam; and
a second birefringent crystal positioned proximate to the first birefringent crystal and to configured to receive the first light beam and the delayed second light beam, the second birefringent crystal configured to further delay the delayed second light beam and spatially recombine the delayed second light beam and the first light beam into a recombined laser light beam and output the recombined laser light beam;
at least one scanning mirror configured to reflect the recombined laser light beam; and
a drive circuit configured to provide an excitation signal to excite motion of the scanning mirror to reflect the recombined laser light beam in a raster pattern of scan lines.

13. The scanning laser projector of claim 12, wherein the first birefringent crystal has a first input surface and a first output surface, and wherein the second birefringent crystal has a second input surface and a second output surface, and wherein the first input surface, the first output surface, the second input surface, and the second output surface are all parallel, and wherein further comprising anti-reflective coatings are applied to each of the first input surface, the first output surface, the second input surface, and the second output surface.

14. The scanning laser projector of claim 13, wherein the first birefringent crystal and the second birefringent crystal each comprise a uniaxial birefringent crystal, and wherein the first birefringent crystal has a first length, the second birefringent crystal has a second length, and wherein the first length is substantially equal to the second length.

15. A method of projecting an image, comprising:
generating a laser light beam;
splitting the laser light beam into a first light beam and a second light beam with a first birefringent element;
spatially recombining the first light beam and the second light beam with a second birefringent element to generate a recombined laser beam; and
exciting motion of a scanning mirror to reflect the recombined laser beam in a raster pattern of scan lines.

16. The method of claim 15, further comprising adjusting the laser light beam to have optical power along two orthogonal polarizations.

17. The method of claim 15, wherein the first light beam has an S polarization and the second light beam has a P polarization.

18. The method of claim 15, wherein the splitting the laser light beam and spatially recombining the first light beam and the second light beam introduces a relative delay between the first light beam and the second light beam, where the relative delay is greater than a coherence length of the laser light beam.

19. The method of claim 15, wherein the first birefringent element and the second birefringent element each comprise a uniaxial birefringent crystal.

20. The method of claim 15, wherein the first birefringent element has a first input surface and a first output surface, and wherein the second birefringent element has a second input surface and a second output surface, and wherein the first input surface, the first output surface, the second input surface, and the second output surface are all parallel.
